(19) United States
(12) Patent Application Publication
(10) Pub. No.: US 2008/0077514 A1
(43) Pub. Date: Mar. 27, 2008

(54) Method and apparatus for performing a financial transaction

(76) Inventor: Matt E. Hart, Lunenburg, MA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/523,929

(22) Filed: Sep. 19, 2006

(51) Int. Cl. G06Q 40/00

(52) U.S. Cl. 705/35; 235/380

(57) ABSTRACT

A system that facilitates performing a financial transaction. During operation, the system receives a request on behalf of a user to perform the financial transaction, wherein the request includes parameters for the financial transaction. Next, the system retrieves a set of rules associated with financial sources which can be used to fulfill the financial transaction, wherein the rules for a given financial source can be used to determine financial benefits associated with using the given financial source. The system then applies the set of rules to the parameters to determine the financial benefits associated with using each of the financial sources. Next, the system analyzes the determined financial benefits to identify one or more financial sources that meet a selection criteria. The system then fulfills the financial transaction using the one or more identified financial sources.

### BACKGROUND

The present invention relates to techniques for facilitating financial transactions.

Credit card issuers typically provide value-added programs that reward consumers for using specific credit cards. The rewards associated with these value-added programs are based on the purchases made by the consumer and can include: airline frequent flyer miles, a percentage of the purchase amount (i.e., cash back), an upgrade to a higher service level provided by the credit card issuer (e.g., gold to platinum status), or points that can be redeemed with partners of the value-added program. Moreover, each value-added program can offer different types of rewards and incentives. For example, a gasoline credit card might give 5% cash back for gasoline purchases, but only 1% cash back for other purchases, whereas an airline credit card might offer double miles for purchases made at supermarkets and single miles for all other purchases.

Furthermore, consumers typically have more than one credit card and rewards cannot be transferred between the value-added programs associated with the different credit cards. Moreover, some value-added programs can only be applied to certain purchases (e.g., gasoline, supermarket, etc.).

These value-added programs are not limited to credit card rewards programs. For example, supermarkets and retailers offer rewards programs that give a consumer a discount on products in exchange for permission to track the buying habits of the consumer.

Keeping track of these value-added programs and determining which credit card and/or other value-added programs generates the best financial benefit for a particular purchase is a complicated task.

### SUMMARY

One embodiment of the present invention provides a system that facilitates performing a financial transaction. During operation, the system receives a request on behalf of a user to perform the financial transaction, wherein the request includes parameters for the financial transaction. Next, the system retrieves a set of rules associated with financial sources which can be used to fulfill the financial transaction, wherein the rules for a given financial source can be used to determine financial benefits associated with using the given financial source. The system then applies the set of rules to the parameters to determine the financial benefits associated with using each of the financial sources. Next, the system analyzes the determined financial benefits to identify one or more financial sources that meet a selection criteria. The system then fulfills the financial transaction using the one or more identified financial sources.

In a variation on this embodiment, a single aggregate financial instrument which aggregates a number of financial sources for the user is used to perform the financial transaction.

In a variation on this embodiment, the financial transaction can include: a credit card transaction, a debit card transaction, an electronics fund transfer (EFT), an automated teller machine (ATM) transaction, a transfer of balance between credit cards, a loan transaction, or any other financial transaction.

In a variation on this embodiment, the set of rules can include a rule that can be used to determine benefits associated with a credit card rewards program, a rule that can be used to determine benefits associated with an airline frequent flyer program, a rule that specifies credit card interest rates, a rule that specifies loan interest rates, or any other rule that can be used to determine benefits associated with a financial source.

In a further variation, while applying the set of rules to the parameters to determine the financial benefits, the system determines an amount of money involved in the financial transaction from the parameters for the financial transaction. For each rule in the set of rules, the system applies the rule to the amount of money to determine a financial benefit of using an associated financial source to fulfill the financial transaction, wherein the financial benefit is specified in a base unit.

In a further variation, the base unit is a unit of currency.

In a further variation, the parameters associated with the financial transaction can include: a merchant identification number, a merchant bank account number, an amount of money involved in the financial transaction, a list of items involved in the financial transaction, and a list of categories corresponding to the list of items.

In a variation on this embodiment, the selection criteria can include: a financial source with the highest financial benefit, a financial source with the lowest financial benefit, a subset of the financial sources with the highest financial benefits, a subset of the financial sources with the lowest financial benefits, a combination of selection criteria, or any other selection criteria.

In a variation on this embodiment, a default rule for a financial source is provided by a financial institution.

In a further variation, a default rule provided by a financial institution can be overridden by a user-specified rule. The user-specified rule can include: a rule to use a given financial source for a given financial transaction, a rule to use a given financial source until a specified balance associated with the financial source is reached, a rule to distribute the financial transaction across a plurality of financial sources, any other rule that overrides the default rule provided by a financial institution.

### BRIEF DESCRIPTION OF THE FIGURES

FIG. 1 presents a block diagram illustrating an aggregated credit card transaction in accordance with an embodiment of the present invention.

FIG. 2 presents a flow chart illustrating the process of fulfilling a financial transaction in accordance with an embodiment of the present invention.

FIG. 3 presents a flow chart illustrating the process of determining a financial benefit of using a given financial source in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention as set forth in the claims. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention aggregates multiple credit cards for a consumer and replaces the multiple credit cards with a single aggregate credit card. In this embodiment, when the consumer makes a purchase using the aggregate credit card, the amount of money associated with the purchase is applied to one or more credit cards that meet specified selection criteria.

Note that the discussion below describes the present invention as applied to credit card transactions. However, the present invention can be applied to any financial transaction wherein a consumer wants to determine the benefits of using one or more financial sources to fulfill the financial transaction.

### Traditional Credit Card Transactions

A typical consumer has a number of credit cards. When making a purchase from a merchant, the consumer chooses one credit card to make the purchase. During this purchase, the merchant uses a point-of-sale device (POS) to initiate a credit card authorization request to determine whether the consumer is authorized to use the chosen credit card to make the purchase. Note that the point-of-sale device can include any type of device which can authorize a purchase using credit or using any other financial source. The point-of-sale device then contacts a clearing house credit processor through a network to request authorization to apply the amount of money associated with the purchase to the chosen credit card.

Note that the networks can generally include any type of wired or wireless communication channel capable of coupling together computing nodes. This includes, but is not limited to, a local area network, a wide area network, a telephone network, or a combination of networks. In one embodiment of the present invention, the network includes the Internet.

Note that the clearing house credit processor can include any financial institution that can process credit card transactions. Also note that more than one clearing house credit processor can be used. Furthermore, note that credit card clearing house processors can be coupled to the same network or coupled to different networks.

Next, the clearing house credit processor analyzes the parameters associated with the authorization request and determines which credit card issuer issued the chosen credit card to the consumer. The clearing house credit processor then sends a request through the network to the determined credit card issuer to authorize the purchase.

Note that credit card issuers typically provide services to multiple consumers. Hence, the credit card issuer first identifies which consumer account is associated with the chosen credit card and then determines whether the amount of money associated with the purchase can be authorized for the identified consumer account. The answer to the authorization request is sent back to the clearing house credit processor which forwards the information back to the POS device. If the amount of money associated with the purchase is authorized, the credit card issuer applies a charge to the identified consumer account for that amount once the transaction is finalized.

The clearing house credit processor then identifies the bank that maintains a merchant account for the merchant based on the parameters associated with the authorization request. A credit for the purchase amount is then applied to the identified merchant bank account.

Note that the above-described process is presented for illustrative purposes only and that the credit card authorization process can be modified without changing the operation of the present invention. Furthermore, note that when applying other value-added programs not associated with credit cards to the purchase, a separate process can be used to authorize and to apply the benefits of the value-added program.

### Aggregated Credit Card Transactions

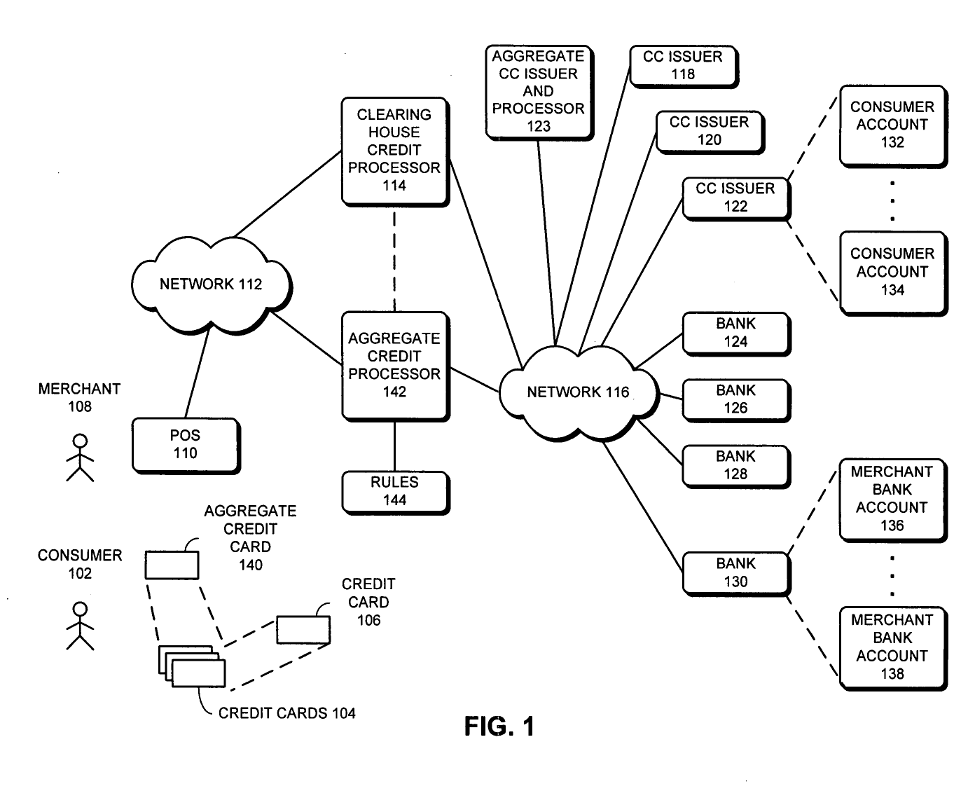

FIG. 1 presents a block diagram illustrating an aggregated credit card transaction in accordance with an embodiment of the present invention. The process is similar to the traditional credit card transaction process described above, with the exception that an aggregated credit card is used.

In one embodiment of the present invention, credit cards 104 for consumer 102 are aggregated into a single aggregate credit card 140. In one embodiment of the present invention, information about the benefits and value-added programs, the interest rates, and credit limits associated with credit cards 104 are stored at aggregate credit processor 142. In another embodiment of the present invention, information about the benefits of value-added programs not associated with credit cards is also stored at aggregate credit processor 142 so that these benefits can be accessed when consumer 102 uses aggregate credit card 140.

In FIG. 1, consumer 102 uses aggregate credit card 140 to make a purchase from merchant 108. During this purchase, merchant 108 uses point-of-sale device (POS) 110 to initiate a credit card authorization request to determine whether consumer 102 is authorized to use aggregate credit card 140 to make the purchase. Point-of-sale device 110 then contacts aggregate credit processor 142 through network 112 to request authorization to apply the amount of money associated with the purchase to aggregate credit card 140.

In one embodiment of the present invention, aggregate credit processor 142 uses rules 144 to determine a financial benefit for using a given credit card associated with aggregate credit card 140. Note that the rules are described in more detail below.

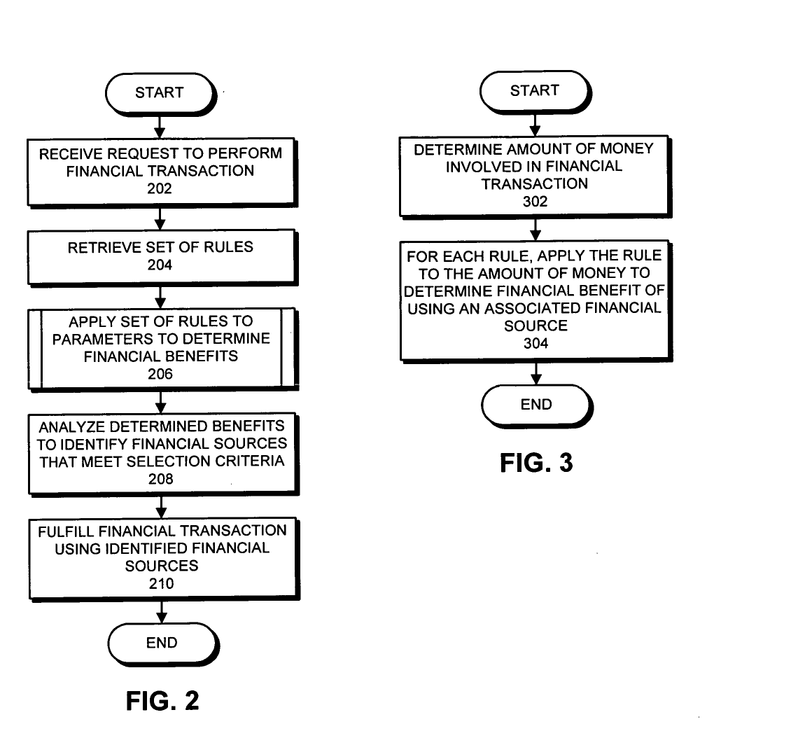

FIG. 2 presents a flow chart illustrating the process of fulfilling a financial transaction using an aggregate financial source in accordance with an embodiment of the present invention. The process begins when the system receives a request on behalf of a user to perform the financial transaction, wherein the request includes parameters for the financial transaction (step 202). Next, the system retrieves a set of rules associated with financial sources which can be used to fulfill the financial transaction, wherein the rules for a given financial source can be used to determine financial benefits associated with using the given financial source (step 204). The system then applies the set of rules to the parameters to determine the financial benefits associated with using each of the financial sources (step 206). Note that step 206 is described in more detail in reference to FIG. 3 below. Next, the system analyzes the determined financial benefits to identify one or more financial sources that meet a selection criteria (step 208). The system then fulfills the financial transaction using the identified financial sources (step 210).

In one embodiment of the present invention, the financial transaction can include, but is not limited to, a credit card transaction, a debit card transaction, an electronics fund transfer (EFT), an automated teller machine (ATM) transaction, a transfer of balance between credit cards, a loan transaction, or any other financial transaction.

In one embodiment of the present invention, the parameters associated with the financial transaction can include, but are not limited to, a merchant identification number, a merchant bank account number, an amount of money involved in the financial transaction, a list of items involved in the financial transaction, and a list of categories corresponding to the list of items.

In one embodiment of the present invention, the selection criteria can include, but are not limited to, a financial source with the highest financial benefit, a financial source with the lowest financial benefit, a subset of the financial sources with the highest financial benefits, a subset of the financial sources with the lowest financial benefits, a combination of selection criteria, or any other selection criteria.

In one embodiment of the present invention, after determining one or more credit cards to use to fulfill the purchase, aggregate credit processor 142 sends a request through network 116 to the credit card issuer(s) that issued the determined credit cards to authorize the purchase. For example, if aggregate credit processor 142 determines that credit card 106 for consumer 102 is the most beneficial credit card to use, aggregate credit processor 142 identifies the credit card issuer that issued credit card 106 to consumer 102. In one embodiment of the present invention, aggregate credit processor 142 determines the credit card issuer that issued credit card 106 to consumer 102 by looking up information about credit card 106 stored on aggregate credit processor 142. For example, aggregate credit processor 142 can determine that credit card issuer 122 issued credit card 106 for consumer 102. As a result, aggregate credit processor 142 sends a request through network 116 to credit card issuer 122 to authorize the purchase.

Note that networks 112 and 116 can generally include any type of wired or wireless communication channel capable of coupling together computing nodes. This includes, but is not limited to, a local area network, a wide area network, a telephone network, or a combination of networks. In one embodiment of the present invention, networks 112 and 116 include the Internet. Also note that networks 112 and 116 can be the same network.

In one embodiment of the present invention, aggregate credit processor 142 uses clearing house credit processor 114 to authorize the purchase. In another embodiment of the present invention, aggregate credit processor 142 sends the authorization request to credit card issuer 122.

Credit card issuer 122 then receives the request and determines the consumer account that is associated with credit card 106. For example, credit card issuer 122 can determine that credit card 106 is associated with consumer account 134. Hence, credit card issuer 122 determines whether the amount of money associated with the purchase can be authorized for consumer account 134. The answer to the authorization request is sent back to aggregate credit processor 142 which forwards the information back to POS device 110. If the amount of money associated with the purchase is authorized, credit card issuer 122 applies a charge to consumer account 134 for that amount once the transaction is finalized.

In one embodiment of the present invention, a credit card issuer is also an aggregate credit processor. In FIG. 1B, aggregate credit card issuer and processor 123 is both an aggregate credit card issuer and an aggregate credit processor. For example, transactions involving aggregate credit card issuer and processor 123 can be as follows. POS device 110 makes an authorization request through clearing house credit processor 114. Clearing house credit processor then queries aggregate credit card issuer and processor 123 to determine whether the customer is authorized to make a purchase using the aggregate credit card 140. Aggregate credit card issuer and processor 123 applies rules associated with aggregate credit card 140 and determines which credit card accounts associated with aggregate credit card 140 are to be charged. Aggregate credit card issuer and processor 123 then processes the charge using the determined credit card accounts through clearing house credit processor 114. Clearing house credit processor 114 checks with credit card issuers that issued the determined credit cards (e.g., credit card issuer 122). In one embodiment of the present invention, aggregate credit card issuer and processor 123 is not a credit card issuer that is queried by credit card processor 114. Finally, if the credit card issuers authorize the purchase amount, the authorizations are returned through aggregate credit card issuer and processor 123 and back to merchant 108.

### Rules

In one embodiment of the present invention, a rule for a value-added program associated with a financial source is used to determine a financial benefit of using the financial source. In one embodiment of the present invention, the set of rules can include, but are not limited to, a rule that can be used to determine benefits associated with a credit card rewards program, a rule that can be used to determine benefits associated with an airline frequent flyer program, a rule that specifies credit card interest rates, a rule that specifies loan interest rates, or any other rule that can be used to determine benefits associated with a financial source.

FIG. 3 presents a flow chart illustrating the process of applying the set of rules to the parameters to determine the financial benefits in accordance with an embodiment of the present invention. The process begins when the system determines an amount of money involved in the financial transaction from the parameters for the financial transaction (step 302). For each rule in the set of rules, the system applies the rule to the amount of money to determine a financial benefit of using an associated financial source to fulfill the financial transaction, wherein the financial benefit is specified in a base unit (step 304).

In one embodiment of the present invention, the base unit is a unit of currency. For example, the unit of currency can be a dollar.

In one embodiment of the present invention, a default rule for a financial source is provided by a financial institution. In this embodiment, an employee of a financial institution can use an application programming interface (API) to enter information about the financial source. In another embodiment of the present invention, a third party processor can manually create a default rule for a financial source provided by a financial institution.

In one embodiment of the present invention, an aggregate credit processor uses the parameters associated with a purchase to determine information which is used to select a credit card to fulfill a transaction. For example, the aggregate credit processor can determine a merchant identifier (ID) associated with the purchase and use this merchant ID to determine whether using a given credit card at this merchant is financially beneficial as compared to using the other credit cards.

In some situations, a consumer may want to override a default rule provided by a financial institution. For example, if a consumer is going to visit a theme park for a vacation, the consumer may prefer to have all purchases made in the theme park go to a credit card associated with the theme park. Hence, the consumer may modify the default rule for the credit card associated with the theme park to increase the financial benefit of using the credit card at the theme park. Similarly, if a consumer wants to accumulate reward points on a given credit card, the consumer can modify the default rule for the given credit card to increase the financial benefit of using the given credit card.

Hence, in one embodiment of the present invention, a default rule provided by a financial institution can be overridden by a user-specified rule. In this embodiment, the user-specified rule can include, but is not limited to: a rule to use a given financial source for a given financial transaction; a rule to use a given financial source until a specified balance associated with the financial source is reached; a rule to distribute the financial transaction across a plurality of financial sources; or any other rule that overrides the default rule provided by a financial institution.

Determining the financial benefit of a given financial source can be done on a case-by-case basis. For example, determining the financial benefit of a cash back program is different than determining the financial benefit of an airline frequent flyer program. Several examples of determining the financial benefit of value-added programs are illustrated below.

Determining the financial benefit of a cash-back valued-added program can be straightforward. For example, if a credit card gives 5% cash back on all purchases, the default rule for this credit card can be set so that the financial benefit of using this credit card, in terms of the base unit, is 0.05. Similarly, if a credit card gives 5% cash back on gasoline purchases, but only 1% cash back on all other purchases, the default rule for this credit card can be set so that the financial benefit of using this credit card in terms of the base unit is 0.05 for gasoline purchases and 0.01 for all other purchases. Hence, in one embodiment of the present invention, the default rule for a credit card with a cash back program can be set so that the financial benefit is proportional to a percentage of a base unit.

Airline frequent flyer programs sometimes reward consumers with double or triple miles depending on the type of items purchased or depending on the vendor from which the purchase was made. For example, consider a credit card that gives triple miles for items purchased at Store A and single miles for all other purchases. The default rule for this credit card can be set so that the financial benefit of using this credit card to make a purchase from Store A is worth three times as much as purchases made from other stores. For example, the default rule can be set so that the financial benefit of using this credit card in Store A is 3 and the financial benefit of using this credit card for other purchases is 1. Hence, in this example, the default rule for a credit card associated with an airline frequent flyer program is set so that the financial benefit is proportional to the miles offered for given purchases.

As pointed out above, comparing one value-added program to another can be difficult. For example, consider two credit cards with different types of value-added programs. The first credit card gives 3% cash back on all purchases, whereas the second credit card gives double miles for purchases made at gas stations and single miles for all other purchases. In one embodiment of the present invention, the value-added programs are compared by calculating a real cash value for the value-added program. For example, if the cost to upgrade from economy class to first class on a single leg of a flight is 15,000 miles, and if the cash value in the eyes of the consumer for the upgrade is $1500, then the cash value of a single mile in terms of the base unit is 0.1 and double miles purchases are worth 0.2. These numbers are both larger than the 3% or 0.03 cash value associated with the value-added program for the first credit card. Hence, if the consumer is making a gasoline purchase, the second credit card is a better deal and the aggregate credit processor chooses the second credit card to fulfill the gasoline purchase.

Some credit card value-added programs provide multiple ways to redeem rewards. For example, a credit card issuer may give points based on the type of purchase made, as described above. However, the actual financial benefit of choosing a given credit card can depend on the type of redemption made. Consider a consumer with two credit cards. The first credit card gives 3% cash back on all purchases and the second credit card gives double points for gasoline purchases and single points for all other purchases. Furthermore, the financial institution that issued the second credit card can have multiple rewards partners, such as airlines and stores. The points earned on the second credit card can be redeemed at these rewards partners, but the financial benefit of redeeming the points at each rewards partner can be different. For example, for the second credit card, one point can be used to redeem one frequent flyer mile or one point can be used to get $0.03 cash back. Hence, for the second credit card, not only does the financial benefit of the value-added program need to be accounted for, but each possible redemption program must also be accounted for.

In order to determine the financial benefit of the value-added program for the second credit card relative to the first credit card, information about the redemption preferences for the consumer are required. For example, if the consumer is a frequent traveler, the consumer may prefer to accumulate as many frequent flyer miles as possible. Hence, the financial benefit of the second credit card for this consumer is determined relative to the frequent flyer miles redemption program. In one embodiment of the present invention, if the credit card has multiple ways to earn points (or rewards) and multiple ways to redeem the rewards, the financial institution issuing the credit card selects a default rewards-redemption program on which to base the default rule. In another embodiment of the present invention, the financial institution uses statistical analysis to determine how a typical consumer redeems rewards in order to select the default rewards-redemption program. In another embodiment of the present invention, the user specifies the rewards-redemption program on which to base the rule.

In one embodiment of the present invention, the default rule can be modified by the financial institution if there is a promotion.

One embodiment of the present invention aggregates information about rewards programs that are not based on financial instruments and uses parameters associated with the purchase to determine whether to apply these rewards program to the purchase. These rewards programs can include, but are not limited to, supermarket rewards programs and other rewards programs that track consumer spending habits in exchange for a discount on purchases. For example, a supermarket may provide a rewards card that gives holders of the rewards card a discount on items purchased at the supermarket. If a consumer is shopping at the supermarket that issued the rewards card to the consumer, aggregate credit processor 142 can use the parameters associated with the purchase to determine if a rule associated with the rewards card exists. If so, aggregate credit processor 142 can apply the rewards card to the purchase. This selection process can occur independently or in conjunction with the selection process associated with the financial sources. Hence, an optimal set of value-added programs can be identified and applied to a given purchase.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for performing a financial transaction, comprising:
receiving a request on behalf of a user to perform the financial transaction, wherein the request includes parameters for the financial transaction;
retrieving a set of rules associated with financial sources which can be used to fulfill the financial transaction, wherein the rules for a given financial source can be used to determine financial benefits associated with using the given financial source;
applying the set of rules to the parameters to determine the financial benefits associated with using each of the financial sources;
analyzing the determined financial benefits to identify one or more financial sources that meet a selection criteria; and
fulfilling the financial transaction using the one or more identified financial sources.

2. The method of claim 1, wherein a single aggregate financial instrument which aggregates a number of financial sources for the user is used to perform the financial transaction.

3. The method of claim 1, wherein the financial transaction can include:
a credit card transaction;
a debit card transaction;
an electronics fund transfer (EFT);
an automated teller machine (ATM) transaction;
a transfer of balance between credit cards;
a loan transaction; or
any other financial transaction.

4. The method of claim 1, wherein the set of rules can include:
a rule that can be used to determine benefits associated with a credit card rewards program;
a rule that can be used to determine benefits associated with an airline frequent flyer program;
a rule that specifies credit card interest rates;
a rule that specifies loan interest rates; or
any other rule that can be used to determine benefits associated with a financial source.

5. The method of claim 4, wherein applying the set of rules to the parameters to determine the financial benefits involves:
determining an amount of money involved in the financial transaction from the parameters for the financial transaction; and
for each rule in the set of rules, applying the rule to the amount of money to determine a financial benefit of using an associated financial source to fulfill the financial transaction, wherein the financial benefit is specified in a base unit.

6. The method of claim 5, wherein the base unit is a unit of currency.

7. The method of claim 4, wherein the parameters associated with the financial transaction can include:
a merchant identification number;
a merchant bank account number;
an amount of money involved in the financial transaction;
a list of items involved in the financial transaction; and
a list of categories corresponding to the list of items.

8. The method of claim 1, wherein the selection criteria can include:
a financial source with the highest financial benefit;
a financial source with the lowest financial benefit;
a subset of the financial sources with the highest financial benefits;
a subset of the financial sources with the lowest financial benefits;
a combination of selection criteria; or
any other selection criteria.

9. The method of claim 1, wherein a default rule for a financial source is provided by a financial institution.

10. The method of claim 9,
wherein a default rule provided by a financial institution can be overridden by a user-specified rule; and
wherein the user-specified rule can include:
a rule to use a given financial source for a given financial transaction;
a rule to use a given financial source until a specified balance associated with the financial source is reached;
a rule to distribute the financial transaction across a plurality of financial sources; or
any other rule that overrides the default rule provided by a financial institution.

11. A computer-readable storage medium storing instructions that when executed by a computer cause the computer to perform a method for performing a financial transaction, wherein the method comprises:
receiving a request on behalf of a user to perform the financial transaction, wherein the request includes parameters for the financial transaction;
retrieving a set of rules associated with financial sources which can be used to fulfill the financial transaction, wherein the rules for a given financial source can be used to determine financial benefits associated with using the given financial source;
applying the set of rules to the parameters to determine the financial benefits associated with using each of the financial sources;
analyzing the determined financial benefits to identify one or more financial sources that meet a selection criteria; and
fulfilling the financial transaction using the one or more identified financial sources.

12. The computer-readable storage medium of claim 11, wherein a single aggregate financial instrument which aggregates a number of financial sources for the user is used to perform the financial transaction.

13. The computer-readable storage medium of claim 11, wherein the financial transaction can include:
a credit card transaction;
a debit card transaction;
an electronics fund transfer (EFT);
an automated teller machine (ATM) transaction;
a transfer of balance between credit cards;
a loan transaction; or
any other financial transaction.

14. The computer-readable storage medium of claim 11, wherein the set of rules can include:
a rule that can be used to determine benefits associated with a credit card rewards program;
a rule that can be used to determine benefits associated with an airline frequent flyer program;
a rule that specifies credit card interest rates;
a rule that specifies loan interest rates; or
any other rule that can be used to determine benefits associated with a financial source.

15. The computer-readable storage medium of claim 14, wherein applying the set of rules to the parameters to determine the financial benefits involves:
determining an amount of money involved in the financial transaction from the parameters for the financial transaction; and
for each rule in the set of rules, applying the rule to the amount of money to determine a financial benefit of using an associated financial source to fulfill the financial transaction, wherein the financial benefit is specified in a base unit.

16. The computer-readable storage medium of claim 15, wherein the base unit is a unit of currency.

17. The computer-readable storage medium of claim 14, wherein the parameters associated with the financial transaction can include:
a merchant identification number;
a merchant bank account number;
an amount of money involved in the financial transaction;
a list of items involved in the financial transaction; and
a list of categories corresponding to the list of items.

18. The computer-readable storage medium of claim 11, wherein the selection criteria can include:
a financial source with the highest financial benefit;
a financial source with the lowest financial benefit;
a subset of the financial sources with the highest financial benefits;
a subset of the financial sources with the lowest financial benefits;
a combination of selection criteria; or
any other selection criteria.

19. The computer-readable storage medium of claim 11, wherein a default rule for a financial source is provided by a financial institution.

20. The computer-readable storage medium of claim 19,
wherein a default rule provided by a financial institution can be overridden by a user-specified rule; and
wherein the user-specified rule can include:
a rule to use a given financial source for a given financial transaction;
a rule to use a given financial source until a specified balance associated with the financial source is reached;
a rule to distribute the financial transaction across a plurality of financial sources; or
any other rule that overrides the default rule provided by a financial institution.

21. An apparatus that performs a financial transaction, comprising:
a receiving mechanism configured to receive a request on behalf of a user to perform the financial transaction, wherein the request includes parameters for the financial transaction; and
an aggregate-financial-source processor configured to:
retrieve a set of rules associated with financial sources which can be used to fulfill the financial transaction, wherein the rules for a given financial source can be used to determine financial benefits associated with using the given financial source;
apply the set of rules to the parameters to determine the financial benefits associated with using each of the financial sources;
analyze the determined financial benefits to identify one or more financial sources that meet a selection criteria; and to
fulfill the financial transaction using the one or more identified financial sources.

22. A method for aggregating financial sources for a user, comprising:
receiving information about the financial sources for the user that are to be aggregated;
obtaining a set of rules that can be used to determine financial benefits associated with using the financial sources; and
issuing an aggregate financial instrument to the user, wherein the aggregate financial instrument is associated with the financial sources.

23. The method of claim 22, wherein the set of rules is stored on the aggregate financial instrument.

24. The method of claim 22, wherein the set of rules is stored on a system which processes financial transactions for aggregate financial sources.

25. The method of claim 22, wherein the aggregate financial instrument can be used to fulfill a financial transaction.

26. The method of claim 25, wherein the financial transaction can include:
a credit card transaction;
a debit card transaction;
an electronics find transfer (EFT);
an automated teller machine (ATM) transaction;
a transfer of balance between credit cards;
a loan transaction; or
any other financial transaction.

27. The method of claim 22, wherein the set of rules can include:
a rule that can be used to determine benefits associated with a credit card rewards program;
a rule that can be used to determine benefits associated with an airline frequent flyer program;
a rule that specifies credit card interest rates;
a rule that specifies loan interest rates; or
any other rule that can be used to determine benefits associated with a financial source.

28. The method of claim 22, wherein the set of rules can be used to determine the financial benefits associated with using the financial sources, and wherein the method further comprises:
collecting information about the financial sources from one or more financial institutions; and
generating rules that can be used to determine the financial benefits associated with using the financial sources based on the collected information.

29. The method of claim 22,
wherein a rule for a financial source is a user-specified rule; and
wherein the user-specified rule can include:
a rule to use a given financial source for a given financial transaction;
a rule to use a given financial source until a specified balance associated with the financial source is reached;
a rule to distribute the financial transaction across a plurality of financial sources; or
any other rule that overrides a default rule.

30. A computer-readable storage medium storing instructions that when executed by a computer cause the computer to perform a method for aggregating financial sources for a user, wherein the method comprises:
receiving information about the financial sources for the user that are to be aggregated;
obtaining a set of rules that can be used to determine financial benefits associated with using the financial sources; and
issuing an aggregate financial instrument to the user, wherein the aggregate financial instrument is associated with the financial sources.

31. The computer-readable storage medium of claim 30, wherein the set of rules is stored on the aggregate financial instrument.

32. The computer-readable storage medium of claim 30, wherein the set of rules is stored on a system which processes financial transactions for aggregate financial sources.

33. The computer-readable storage medium of claim 30, wherein the aggregate financial instrument can be used to fulfill a financial transaction.

34. The computer-readable storage medium of claim 33, wherein the financial transaction can include:
a credit card transaction;
a debit card transaction;
an electronics find transfer (EFT);
an automated teller machine (ATM) transaction;
a transfer of balance between credit cards;
a loan transaction; or
any other financial transaction.

35. The computer-readable storage medium of claim 30, wherein the set of rules can include:
a rule that can be used to determine benefits associated with a credit card rewards program;
a rule that can be used to determine benefits associated with an airline frequent flyer program;
a rule that specifies credit card interest rates;
a rule that specifies loan interest rates; or
any other rule that can be used to determine benefits associated with a financial source.

36. The computer-readable storage medium of claim 30, wherein the set of rules can be used to determine the financial benefits associated with using the financial sources, and wherein the method further comprises:
collecting information about the financial sources from one or more financial institutions; and
generating rules that can be used to determine the financial benefits associated with using the financial sources based on the collected information.

37. The computer-readable storage medium of claim 30,
wherein a rule for a financial source is a user-specified rule; and
wherein the user-specified rule can include:
a rule to use a given financial source for a given financial transaction;
a rule to use a given financial source until a specified balance associated with the financial source is reached;
a rule to distribute the financial transaction across a plurality of financial sources; or
any other rule that overrides a default rule.

38. An apparatus that aggregates financial sources for a user, comprising:
a receiving mechanism configured to receive information about the financial sources for the user that are to be aggregated;
a rules mechanism configured to obtain a set of rules that can be used to determine financial benefits associated with using the financial sources; and
an issuing mechanism configured to issue an aggregate financial instrument to the user, wherein the aggregate financial instrument is associated with the financial sources.

39. A method for performing a financial transaction, comprising:
receiving an aggregate financial instrument from a user during a financial transaction, wherein the aggregate financial instrument is associated with a number of financial sources;
transmitting parameters associated with the financial transaction to an aggregate-financial-source processor to authorize the financial transaction, wherein the parameters include information about the aggregate financial source;
receiving a response from the aggregate-financial-source processor indicating whether the financial transaction is authorized; and
if the financial transaction is authorized, fulfilling the financial transaction.

40. The method of claim 39, wherein the aggregate-financial-source processor determines whether the financial transaction is authorized by:
retrieving a set of rules associated with the financial sources, wherein the rules for a given financial source can be used to determine financial benefits associated with using the given financial source;
applying the set of rules to the parameters to determine the financial benefits associated with using each of the financial sources;
analyzing the determined financial benefits to identify one or more financial sources that meet a selection criteria; and
authorizing the financial transaction for the one or more identified financial sources; and
sending a response indicating that the financial transaction has been authorized.

41. A method for performing a financial transaction, comprising:
receiving a request at a financial institution to authorize the financial transaction involving a financial source maintained by the financial institution, wherein the financial source is one of a number of financial sources associated with an aggregate financial instrument, and wherein the request was initiated by an aggregate-financial-source processor;
determining whether the financial source can be used to fulfill the financial transaction; and
if so, transmitting a response to the aggregate-financial-source processor indicating that the financial source can be used to fulfill the financial transaction.

42. The method of claim 41, wherein prior to receiving the request to authorize the financial transaction, the aggregate-financial-source processor determines one or more financial sources to fulfill the financial transaction by:
retrieving a set of rules associated with the financial sources, wherein the rules for a given financial source can be used to determine financial benefits associated with using the given financial source;
applying the set of rules to parameters associated with the financial transaction to determine the financial benefits associated with using each of the financial sources;
analyzing the determined financial benefits to identify one or more financial sources that meet a selection criteria; and
for each financial source that meets the selection criteria, initiating an authorization request directed to the financial institution that maintains the financial source.

43. A computer-readable storage medium storing data associated with a financial source, wherein the data includes:
an account number, wherein the account number is associated with an aggregate financial instrument, which is associated with multiple financial sources; and
an identifier for a financial-source processor, wherein the financial-source processor fulfills a transaction involving the aggregate financial source by:
retrieving a set of rules associated with the financial sources, wherein the rules for a given financial source can be used to determine financial benefits associated with using the given financial source;
applying the set of rules to the parameters to determine the financial benefits associated with using each of the financial sources;
analyzing the determined financial benefits to identify one or more financial sources that meet a selection criteria; and
fulfilling the financial transaction using the one or more identified financial sources.
